(19) United States
(12) Patent Application Publication
(10) Pub. No.: US 2004/0006587 A1
(43) Pub. Date: Jan. 8, 2004

(54) Information handling system and method for clustering with internal cross coupled storage

(75) Inventors: Daniel Raymond McConnell, Round Rock, TX (US); Ahmad Hassan Tawil, Round Rock, TX (US)

Correspondence Address: Michael A. Hawes, Baker Botts L.L.P., One Shell Plaza, 910 Louisiana Street, Houston, TX, 77002-4995, US

(73) Assignee: Dell Products L.P.

(21) Appl. No.: 10/188,644

(22) Filed: Jul. 2, 2002

(51) Int. Cl. G06F 15/16

(52) U.S. Cl. 709/202

(57) ABSTRACT

An information handling system is disclosed. The system includes a first node having a first clustering agent. The first node also includes a first mirror storage agent that is coupled to the first clustering agent and a first internal storage facility. The system also includes a second node having a second clustering agent that is coupled to communicate with the first clustering agent. The second node also includes a second mirror storage agent coupled to the second clustering agent and a second internal storage facility. The first and second mirror storage agents receive storage commands. Those storage commands are relayed from each mirror storage agent to both the first and second internal storage facilities.

### TECHNICAL FIELD

The present disclosure relates generally to the field of information handling systems and, more particularly, to an information handling system and method for clustering with internal cross coupled storage.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems are often modified with the intent of reducing failures and downtime. One general method for increasing the reliability of an information handling system is to add redundancies. For example, if the malfunction of a processor would cause the failure of an information handling system, a second processor can be added to take over the functions performed by the first processor to prevent downtime of the information handling system in the event the first processor fails. Such redundancy can also be supplied for resources other than processing functionality. For example, redundant functionality for communications or storage, among other capabilities, can be provided in an information handling system.

Clustering a group of nodes into an information handling system, allows for the system to retain functionality even though a node is lost as long as at least one node remains. Such a cluster can include two or more nodes. In a conventional cluster, the nodes are connected to each other by communications hardware such as ethernet. The nodes also share a storage facility through the communications hardware. Such a storage facility external to the nodes increases the cost of the cluster beyond the cost of the nodes.

### SUMMARY

In accordance with the present disclosure, an information handling system is disclosed. The information handling system includes a first node having a first clustering agent. The first node also includes a first mirror storage agent that is coupled to the first clustering agent and a first internal storage facility. The system also includes a second node having a second clustering agent that is coupled to communicate with the first clustering agent. The second node also includes a second mirror storage agent coupled to the second clustering agent and a second internal storage facility. The first and second mirror storage agents receive storage commands. Those storage commands are relayed from each mirror storage agent to both the first and second internal storage facilities.

In another implementation of the present disclosure, a method of clustering in an information handling system is disclosed. The method includes accessing storage for applications running on a plurality of nodes using virtual quorums in each node. Each node has an internal storage facility. The virtual quorums receive storage commands that are processed by a mirror agent in each node. Each mirror agent relays the storage commands to the internal storage facilities of each node. A clustering agent on each node monitors the information handling system.

In another implementation of the present disclosure, a method of clustering in an information handling system is disclosed. The method includes defining at each of two nodes a logical storage unit corresponding to a locally attached storage device. The logical storage units are then interfaced through iSCSI targets at the nodes to expose iSCSI logical units. Each node is connected to both iSCSI logical units using an iSCSI initiator. Each node uses a local volume manager to configure a RAID 1 set comprising both iSCSI logical units. The RAID 1 sets are then identified to a clustering agent on each node as quorum drives.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a block diagram of a clustered information handling system;

FIG. 2 is a functional block diagram of a two node cluster with cross coupled storage;

FIG. 3 is a flow diagram of a method for clustering an information handling system using cross coupled storage; and

FIG. 4 is a flow diagram of a method for clustering a three node information handling system using cross coupled storage.

### DETAILED DESCRIPTION

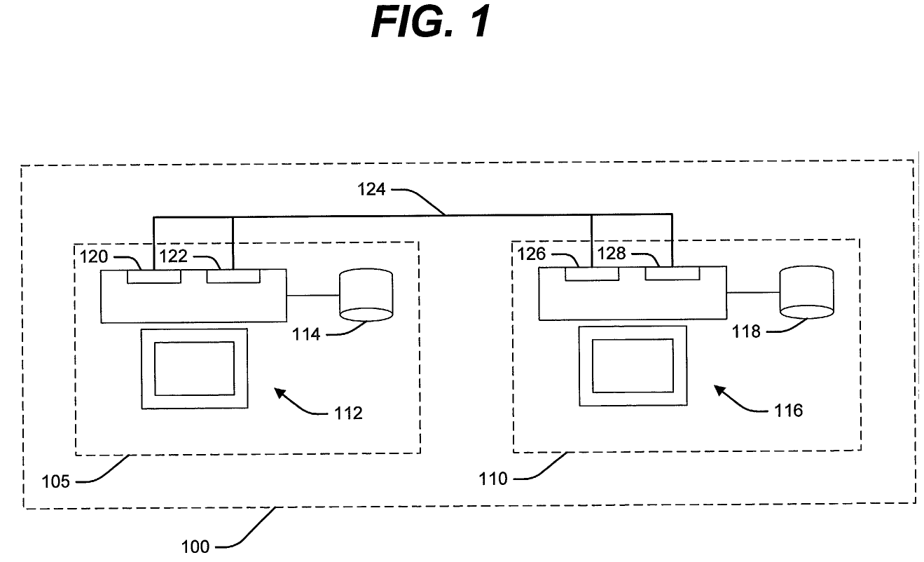

The present disclosure concerns an information handling system and method for clustering with internal cross coupled storage. FIG. 1 depicts a two node cluster. The cluster is designated generally as 100. A first node 105 and a second node 110 form the cluster 100. In alternative implementations, the cluster can include a different number of nodes. In one implementation, the first node 105 includes a server 112 that has locally attached storage 114. A server is a computer or device on a network that manages network resources. In another implementation, the first node 105 includes a Network-Attached Storage (NAS) Device. In another implementation, the first node 105 includes a workstation. The storage facility 114 can be a hard disk drive or other type of storage device. The storage can be coupled to the server by any of several connection standards. For example, Small Computer Systems Interface (SCSI), Integrated Drive Electronics (IDE), or Fiber Channel (FC), can be used, among others. The server 112 also includes a first Network Interface Card (NIC) 120 and a second NIC 122 that are each connected to a communications network 124. The NICs are host side adapters which connect to the network through standardized switches at a particular speed. In one implementation, the communications network is ethernet—an industry standard networking technology that supports Internet Protocol (IP). A protocol is a format for transmitting data between devices.

A second node 110 is included in the cluster in communication with the first node 105. In different implementations the second node 110 can be a server or NAS device. The server 116 is connected to the ethernet 124 through a first NIC 126 and a second NIC 128. Through the ethernet, server 112 can communicate with server 116. A storage facility 118 is locally attached to the server 116. By attaching two nodes 105, 110 together to form a cluster 100, software can be run on the cluster 100 such that the cluster 100 can continue to offer availability to the software even if one of the nodes experiences a failure. One example of clustering software is Microsoft Cluster Server (MSCS).

Additional nodes can be added to the cluster 100 by connecting those nodes to the ethernet through NICs. Additional nodes can decrease the probability that the cluster 100 as a whole will fail by providing additional resources in the case of node failure. In one implementation, the cluster 100 can increase availability by maintaining a quorum disk. A quorum disk is accessible by all the nodes in the cluster 100. Such accessibility can be at a particular resolution, for example at the block level. In the event of node failure, the quorum disk should continue to be available to the remaining nodes.

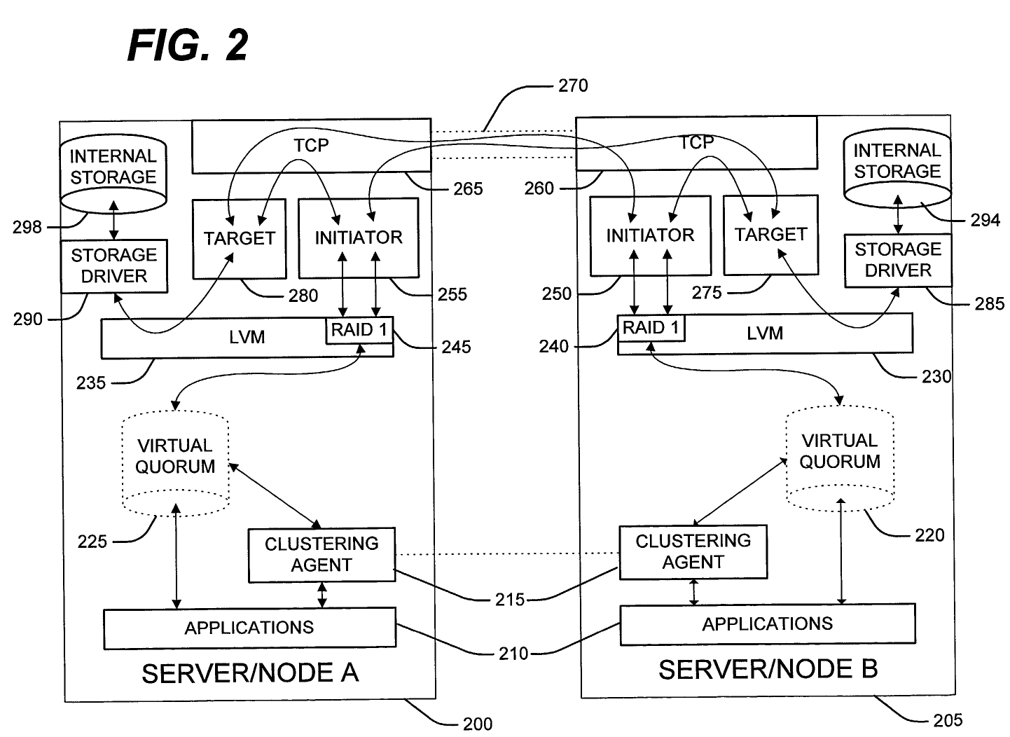

FIG. 2 depicts a functional block diagram of a two node cluster with cross coupled storage. In one implementation, the first node 200 and the second node 205 are servers. Both nodes include applications 210 and clustering agents 215. For example, the applications may be data delivery programs if the servers are acting as a file servers. The clustering agents 215 communicate with each other, as shown by the dotted line. Such communications can physically occur over the ethernet 124, as shown in FIG. 1. One example of a clustering agent is MSCS. In addition to communicating with each other, e.g., exchanging heartbeat signals such that the absence of a heartbeat indicates a failure, the clustering agents 215 communicate with the applications 210 and the respective quorum disks 220, 225 so that failures can be communicated among the clustering agents 215 and the cluster can redirect functionality to maintain availability despite the failure.

In one implementation, the quorum disks 220, 225 are virtual, in that they do not correspond to a single, physical storage facility. Instead, the virtual quorum 225 of the first node 200 is defined and presented by a Local Volume Manager (LVM) 235. The LVM 235 uses a mirror agent 245 to present two physical storage devices as a single virtual disk. In another implementation, the mirror agent 245 presents two virtual storage devices, or one physical storage device and virtual storage device as a single virtual disk. Thus, there can be multiple levels of virtual representation of that physical storage. In one implementation, the mirror agent 245 is a RAID 1 set. The mirror agent 245 receives a storage command that has been sent to the virtual quorum 225 and sends that command to two different storage devices—it mirrors the command. In one implementation write commands and associated data are mirrored, but read commands are not. By mirroring the write commands, the mirror agent 245 maintains identically configured storage facilities, either of which can support the virtual quorum 225 in the event of the failure of the other.

The virtual quorum 220 of the second node 205 is defined and presented by a Local Volume Manager (LVM) 230. The LVM 230 uses a mirror agent 240 to present two physical/virtual storage devices as a single virtual disk. In one implementation, the mirror agent 240 is a RAID 1 set. The mirror agent 240 receives a storage command that has been sent to the virtual quorum 220 and sends that command to two different storage devices—it mirrors the command. In one implementation write commands and associated date are mirrored, but read commands are not. By mirroring the write commands, the mirror agent 240 maintains identically configured storage facilities, either of which can support the virtual quorum 220 in the event of the failure of the other.

In one implementation, in both the first server 200 and the second server 205, the mirrored commands are implemented with an iSCSI initiator 250, 255. The Internet Engineering Task Force is developing the iSCSI industry standard and it is scheduled to be published in mid 2002. The iSCSI standard allows block storage commands to be transported over a network using the Internet Protocol (IP). The commands are transmitted from iSCSI initiators to iSCSI targets. Software for both iSCSI initiators and iSCSI targets is currently available for the Windows 2000 operating system and are available or will soon be available for other operating systems. When the mirrored storage commands reach the iSCSI initiator 250, 255, they are carried to the iSCSI target via sessions that have been previously established using the Transmission Control Protocol (TCP) 260, 265. In one implementation, the iSCSI initiator 250, 255 sends commands and data to the internal iSCSI target using TCP/IP in loopback mode. TCP 260, 265 is used to confirm that commands that are sent are received. Thus the iSCSI runs on top of TCP. The TCP is used both for communications to a node internal target (for the first node 200 iSCSI target 280 is internal) and for communications to a node external target (for the first node 200 iSCSI target 275 is external). Neither the LVM 235 nor the iSCSI initiator 255 can identify a particular iSCSI target as internal or external.

Each node 200, 205 transmits mirrored storage commands to two iSCSI targets 275, 280 and TCP 260, 265 insures that those commands are received by resending them when necessary (or if not an error is returned.) The iSCSI targets 275, 280 receive the commands and, if necessary, translates them into SCSI for the storage driver 285, 290, which translates them to the type of command understood by the physical storage device 294, 298. A return message is sent over the same path. If for example, the applications 210 on the first node 200 initiate a write command, that command is sent to the virtual quorum 225 defined by the LVM 235. The LVM 235 uses the mirror agent 245 to send two commands to the iSCSI initiator 255, which sends those commands each to a different iSCSI target 275, 280. The command sent to the internal iSCSI target 280 is relayed using TCP. The command sent to the external iSCSI target 275 is relayed using TCP on IP on ethernet 270. Both iSCSI targets 275, 280 provide the command to a storage driver 285, 290 which provides a corresponding command to the storage device 294, 298. The storage device 298 sends a response, if any, back to the applications through the storage driver 290, the iSCSI target 280, TCP 265, the iSCSI initiator 255, and the LVM 235 which defines and present the virtual quorum 235. The storage device 294 uses the same path except that the TCP 260, 265 runs on top of IP on an ethernet 270.

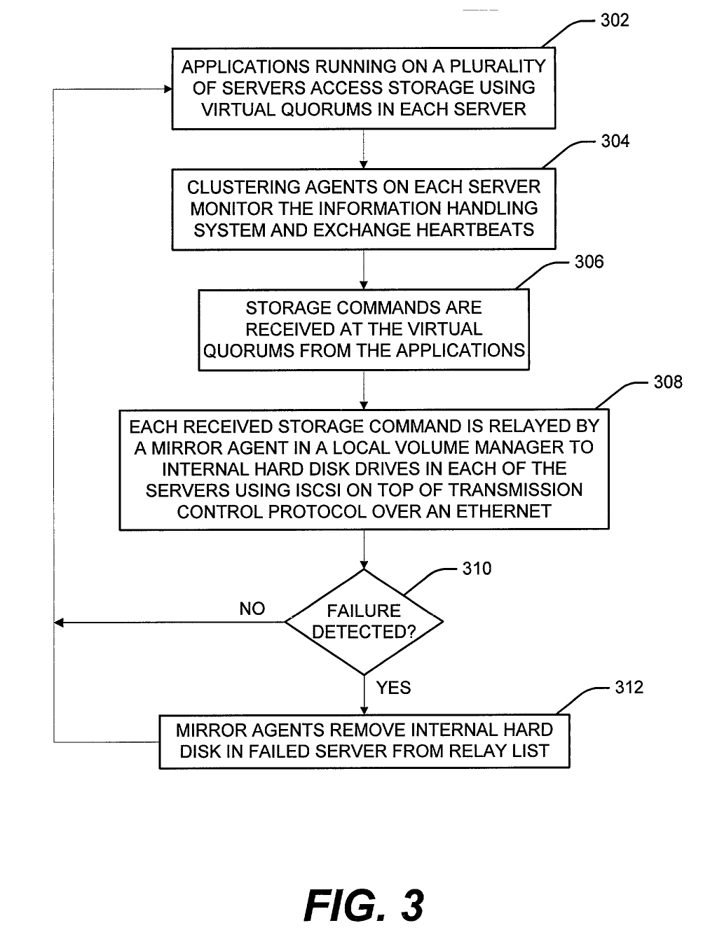

FIG. 3 depicts a flow diagram of a method for clustering an information handling system using cross coupled storage. In one implementation, applications running on a plurality of servers access storage using virtual quorums on each server 302. Clustering agents on each server monitor the information handling system and exchange heartbeat signals 304. The virtual quorums receive storage commands from the applications 306. A mirror agent in a local volume manager in each server relays at least some of the received storage commands to internal hard disk drives in each of the servers 308. The relay transmission occurs using at least iSCSI on top of TCP over an ethernet 308. The clustering agents monitor the information handling system for failures 310. If no failures occur, the storage command relay process of 302-308 continues. If a node failure or internal hard disk drive failure occurs, the mirror agents relay storage commands to the remaining internal hard disk drives 312.

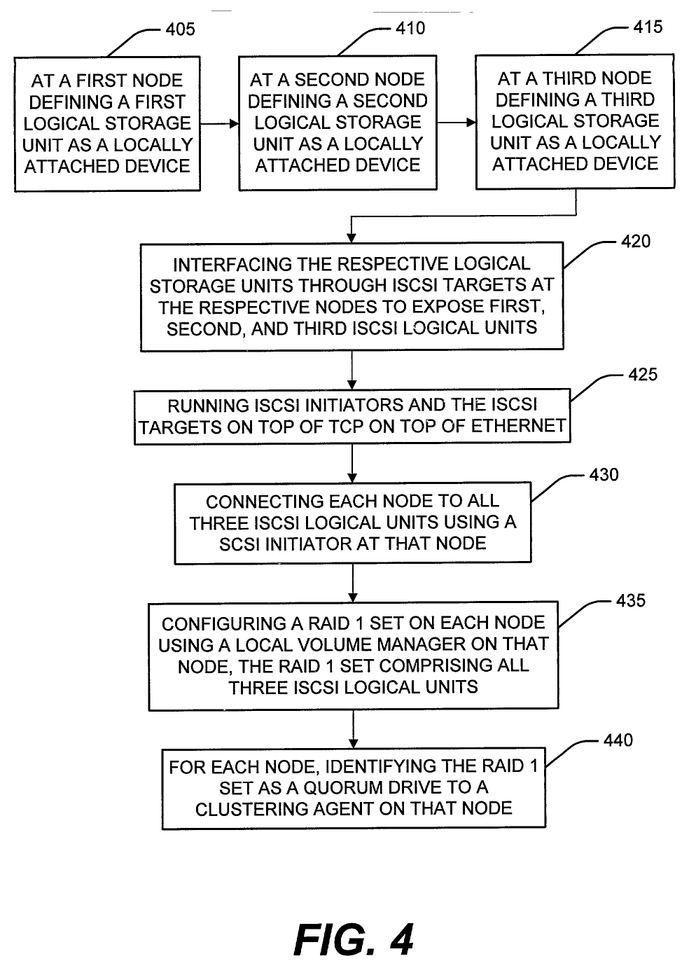

FIG. 4 depicts a flow diagram of a method for clustering a three node information handling system using cross coupled storage. Each of the three nodes defines a logical storage unit as a locally attached device 405, 410, 415. In one implementation, a Logical Unit Number (LUN) is used to define the quorum disk. Each node exposes its logical storage unit as an iSCSI logical unit through its iSCSI target 420. Both the iSCSI targets and an iSCSI initiator at each node are run on top of TCP on top of ethernet 425. In one implementation, TCP is run on top of IP on top of ethernet. The iSCSI initiator on each node will see all three iSCSI logical units when it searches for available iSCSI logical units over the transmission control protocol.

The iSCSI initiator at each node is configured to establish connections to all three iSCSI logical units 430. The local volume manager on each node configures a RAID 1 set consisting of all three iSCSI logical units 435. The RAID 1 set on each node is identified to a clustering agent on that node as the quorum drive 440. As a result, each of the three quorum drives is a triple-mirrored RAID 1 set pointing at the same three physical storage devices, each locally attached to one of the nodes. When an application on one of the nodes writes to the quorum drive identified by the clustering agent, the resulting commands write to all three internal drives, keeping those drives synchronized and the shared view of the quorum drive consistent across all three nodes. If any of the nodes fails, the other two nodes can still access the two remaining versions of the mirrored quorum disk and continue operations. If only the internal storage fails, that node can remain available by accessing the nonlocal versions of its mirrored quorum disk. In alternate implementations, a different number of nodes can employed. In another implementation, some nodes in a cluster employ mirrored quorum drives, while other nodes in the same cluster do not. For example, if four nodes are clustered, the first and second nodes might have internal storage, while the third and fourth do not. All four nodes could maintain quorum drives that are two-way mirrored to the internal storage present in the first and second nodes. Many other variations including both internal and external storage facilities are also possible.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Although the present disclosure has been described in detail, it should be understood that various changes, substitutions, and alterations can be made hereto without departing from the spirit and the scope of the invention as defined by the appended claims. For example, the invention can be used to maintain drives other than quorum drives in a cluster.

What is claimed is:

1. An information handling system, comprising:
a first node, including
a first clustering agent,
a first mirror storage agent coupled to the first clustering agent, and
a first internal storage facility;
a second node, including
a second clustering agent coupled to communicate with the first clustering agent,
a second mirror storage agent coupled to the second clustering agent, and
a second internal storage facility;
wherein the first and second mirror storage agents receive storage commands and relay the storage commands to both the first and second internal storage facilities.

2. The information handling system of claim 1, wherein the first and second nodes are server computer systems.

3. The information handling system of claim 1, further comprising:
a third node, including
a third clustering agent coupled to communicate with the first and second clustering agents,
a third mirror storage agent coupled to the third clustering agent, and
a third internal storage facility;
wherein the first, second, and third mirror storage agents receive storage commands and relay the storage commands to each of the first, second, and third internal storage facilities

4. The information handling system of claim 1, wherein the first and second clustering agents exchange heartbeats.

5. The information handling system of claim 1, wherein the first mirror agent relays storage commands to the second internal storage facility over an ethernet.

6. The information handling system of claim 1, wherein the first mirror agent relays storage commands to the second internal storage facility using transmission control protocol.

7. The information handling system of claim 1, wherein the first mirror agent relays storage commands to the second internal storage facility using iSCSI.

8. The information handling system of claim 1, wherein the first internal storage facility is a hard disk drive.

9. The information handling system of claim 1, wherein the mirror storage agent is part of a local volume manager.

10. A method clustering in an information handling system, comprising the steps of:
(a) accessing storage for applications running on a plurality of nodes using virtual quorums in each node, each node having an internal storage facility;
(b) processing storage commands received by the virtual quorums with mirror agents in each node;
(c) relaying storage commands from the mirror agents to each of the internal storage facilities; and
(d) monitoring the information handling system using a clustering agent on each node.

11. The method of claim 10, wherein the nodes are server computer systems.

12. The method of claim 10, further comprising the steps of:
(e) monitoring the nodes to detect failures and
(f) if one or more nodes fail, relaying storage commands from the mirror agents in the other nodes to each of the internal storage facilities in the other nodes.

13. The method of claim 10, further comprising the step of
(e) exchanging heartbeats between nodes.

14. The method of claim 10, wherein the step of relaying storage commands includes sending commands over an ethernet.

15. The method of claim 10, wherein the step of relaying storage commands includes sending commands using transmission control protocol.

16. The method of claim 10, wherein the step of relaying storage commands includes sending commands using iSCSI.

17. The method of claim 10, wherein the internal storage facilities are hard disk drives.

18. The method of claim 10, wherein the mirror agents are portions of local volume managers on each node.

19. A method of clustering an information handling system, comprising the steps of:
(a) defining at a first node a first logical storage unit as a locally attached storage device;
(b) defining at a second node a second logical storage unit as a locally attached storage device;
(c) interfacing the first logical storage unit through an iSCSI target at the first node to expose a first iSCSI logical unit;
(d) interfacing the second logical storage unit through an iSCSI target at the second node to expose a second iSCSI logical unit;
(e) connecting the first node to the first and second iSCSI logical units using an iSCSI initiator;
(f) configuring a RAID 1 set on the first node using a local volume manager, the RAID 1 set comprising the first and second iSCSI logical units;
(g) identifying the RAID 1 set as a quorum drive to a clustering agent on the first node; and
(h) repeating steps (e)-(g) for the second node.

20. The method of claim 19, further comprising the steps of:
(b′) defining at a third node a third logical storage unit as a locally attached storage device;
(d′) interfacing the third logical storage unit through an iSCSI target at the third node to expose a third iSCSI logical unit;
wherein the step of connecting includes the third iSCSI logical unit; the RAID 1 sets further comprise the third iSCSI logical unit; and steps (e)-(g) are repeated for the third node.

21. The method of claim 19, wherein the iSCSI targets and initiators run on top of transmission control protocol.

22. The method of claim 19, wherein the iSCSI targets and initiators run on top of ethernet.
